(19) United States
(12) Patent Application Publication
(10) Pub. No.: US 2016/0132722 A1
(43) Pub. Date: May 12, 2016

(54) Self-Configuring and Self-Adjusting Distributed Surveillance System

(71) Applicant: Santa Clara University, Santa Clara, CA (US)

(72) Inventors: Christopher Yarp, Palo Alto, CA (US); Ahmed Amer, Santa Clara, CA (US); Sally Wood, Los Altos Hills, CA (US); Nathan M. Fox, Makawao, HI (US); Christopher J. Rapa, Scottsdale, AZ (US); Matthew J. Kelley, Manhattan Beach, CA (US)

(21) Appl. No.: 14/922,997

(22) Filed: Oct. 26, 2015

Related U.S. Application Data
(63) Continuation-in-part of application No. 14/707,772, filed on May 8, 2015, now abandoned.
(60) Provisional application No. 61/990,491, filed on May 8, 2014.

(51) Int. Cl. G06K 9/00; H04N 7/18; G06F 17/30; H04N 5/247

(52) U.S. Cl. CPC G06K 9/00288; H04N 5/247; G06K 9/00255; H04N 7/181; G06F 17/30424

(57) ABSTRACT

Improved facial recognition tracking of individuals throughout a space is provided, as is identification of unexpected behavior. The system can configure itself upon setup and adjust to changing conditions, and is able to intelligently reduce the workload on the facial recognition system. Cameras are placed throughout a building and learn what typical traffic within the building looks like. Over time, the system can track multiple users throughout the system and can automatically learn the average time between cameras. A probability function for each camera can also be determined that give probabilities for each camera to camera path. This approach provides for both limiting the bandwidth and processing power required for facial recognition and also allows for behavioral analysis. This system could be implemented as a distributed system of cameras, each performing its own facial recognition and tracking, and/or with distributed cameras combined with central processing for facial recognition.

### CROSS REFERENCE TO RELATED APPLICATIONS

This application is a continuation in part of U.S. Ser. No. 14/707,772, filed on May 8, 2015, and hereby incorporated by reference in its entirety.

Application Ser. No. 14/707,772 claims the benefit of U.S. provisional patent application 61/990,491, filed on May 8, 2014, and hereby incorporated by reference in its entirety.

### FIELD OF THE INVENTION

This invention relates to surveillance.

### BACKGROUND

Deployment of surveillance systems that make use of automatic facial recognition is becoming more common in a world concerned about security. Whether it is airport security, a large sports venue, or a corporate office building, such surveillance provides a way to track individuals throughout a building and ensure they do not enter restricted areas. Presently, most facial recognition surveillance systems do not apply advanced logic when tracking subjects. In some cases they merely check that individuals are not moving in the wrong direction (i.e., moving the wrong way through an airport security exit) or that an individual is not removed or introduced in a scene. Some systems merely check faces against a white list or black list. Some systems create an index of faces (and sightings) to be viewed later in the course of an investigation. This can be helpful in tagging potentially relevant surveillance recordings in an investigation.

Accordingly, it would be an advance in the art to provide improved facial recognition surveillance methods.

### SUMMARY

In this work, facial recognition surveillance is made more effective by automatically constructing and updating database(s) of at least typical transit times and transition probabilities between camera locations based on observation of normal traffic patterns. Real-time anomaly identification can then be provided by comparing observed behavior with the database information. Applications include security products which could be sold to companies and governments as security appliances or replacement CCTV (closed-circuit television) systems.

### BRIEF DESCRIPTION OF THE DRAWINGS

FIG. 1 schematically shows an example of multiple surveillance cameras deployed in a building.

FIG. 2 is a block diagram of a system suitable for use in practicing the invention.

FIG. 3 is a flow diagram of an exemplary embodiment of the invention.

FIG. 4 is an example of transition probabilities between camera locations.

### DETAILED DESCRIPTION

The system described herein allows for improved tracking of individuals throughout a space as well as identifying unexpected behavior. It is able to self-configure upon setup and to adjust to changing conditions. It does not require time consuming configuration of each camera which may include measuring its field of view and position within a building. As such, it reduces the setup time and cost and improves the scalability of the system. In addition, the camera system is able to intelligently reduce the workload on the facial recognition system.

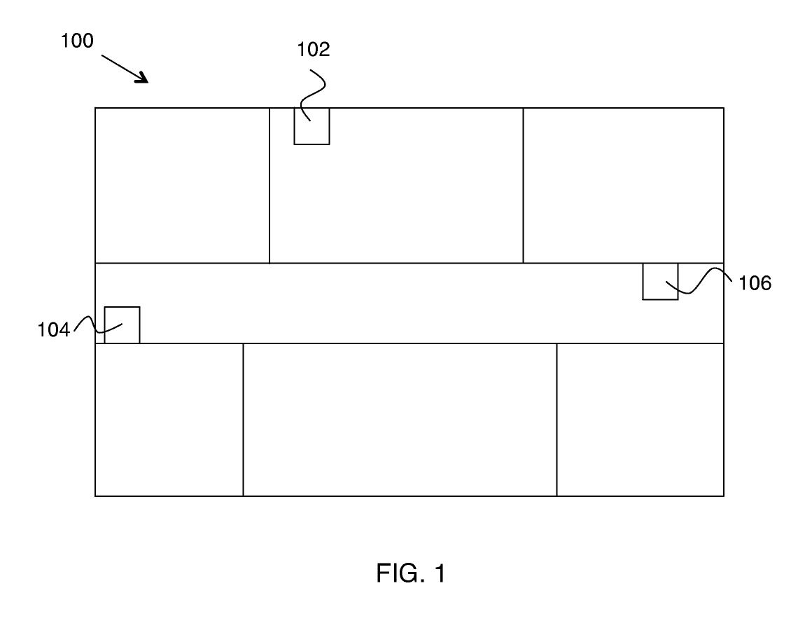

Cameras are placed throughout a building. For example, FIG. 1 shows cameras 102, 104 and 106 deployed in building 100. While their general location may be noted for security purposes (to direct security to the correct location if a threat is detected) cameras are not told their position in the building, nor what is in their field of view (although they may be told if they are in a restricted area). Instead, the cameras learn what typical traffic within the building looks like. To expedite initial configuration, individuals wearing computer identifiable markers can be asked to walk throughout a building and to try to walk along every path they can think of (i.e. though all hallways, doorways, etc.). Each camera tracks the individuals in their field of view and attempts to run facial recognition on the individual. This amounts to performing an initialization run where individuals having markers to facilitate automatic identification walk throughout the region of interest. Alternatively, the database can be constructed automatically without this initial step.

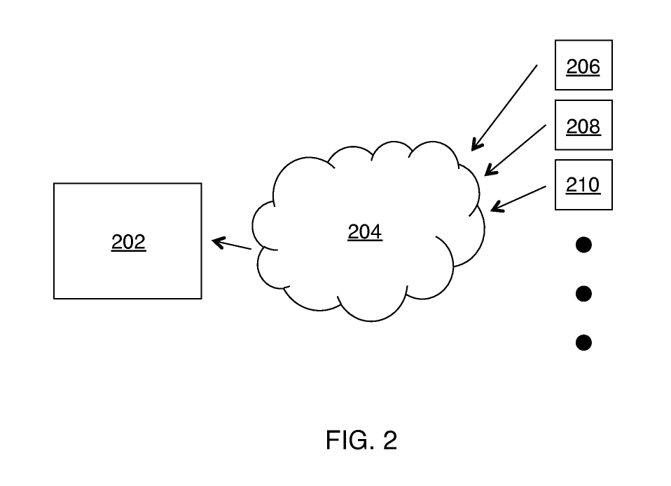

FIG. 2 shows one way to implement such a system. Here cameras 206, 208, 210 etc. are connected via network 204 to a central processor 202 for facial recognition and database update and management. Alternatively, a distributed system of cameras could be used, each camera performing its own facial recognition and tracking. Network 204 can be a wireless network or a wired network.

A wired network, with some wireless bridges if needed, may be preferable in some cases. Many IP surveillance cameras actually use power over Ethernet (PoE) which allows them to be draw power over the network cable (and not require an extra power connection). This is actually convenient for many deployments as routing power can be as big an issue as routing the network cable. Wired networks have the advantage that they can run at higher rates than wireless networks and thus could potentially handle more cameras. They are also not subject to the interference and jamming susceptibilities of wireless networks. Wireless networks have the advantage of easy camera placement if power is available.

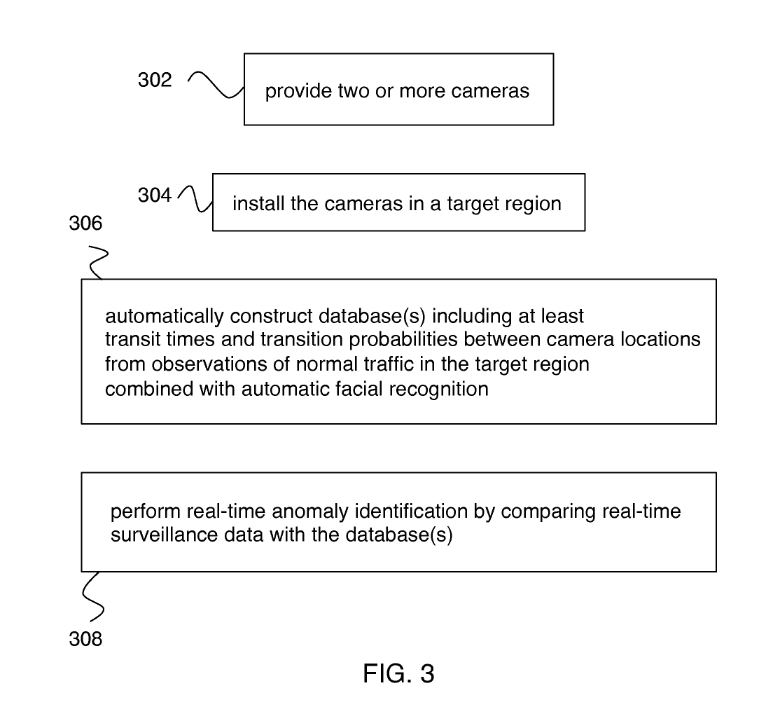

As individuals move throughout the building, a database of typical behavior is automatically constructed by observations from the cameras. This database includes at least transit times and transition probabilities between pairs of cameras. Both directions of travel are considered independently, since going from camera A to camera B and going from camera B to camera A have no intrinsic relationship. FIG. 3 shows an exemplary method along these lines. In step 302, two or more cameras are provided. In step 304, the cameras are installed into a target region (e.g., one or more buildings in a secure facility).

In step 306, one or more databases are constructed from observations of normal traffic. The databases include at least transit time and transition probabilities for camera pairs, and can include further information as described below. In step 308, the databases are used in combination with real time surveillance for real-time anomaly detection. The basic idea is to flag any departure from normal behavior as defined by the databases. Such flagging can be implemented in various ways, and several examples are given below.

For example, an anomaly can be flagged by an observed transit time that falls outside a corresponding predetermined transit time range. The predetermined transit time range can be +/− two standard deviations from the mean transit time based on the accumulated information in the database.

Similarly, an anomaly can be flagged by an observed transition having a corresponding transition probability in the database that is less than a predetermined transition probability threshold. This predetermined transition probability threshold can be 5%.

The system can also automatically check for people appearing or disappearing from surveillance. An anomaly can be flagged by recognition of an individual at a selected camera location who was not recognized at any camera having a transition probability to the selected camera greater than a predetermined appearance threshold. The predetermined appearance threshold can be 5%. This would amount to someone appearing from nowhere as far as the system is concerned.

Similarly, an anomaly can be flagged by recognition of an individual at a selected camera location who was not recognized at any camera having a transition probability from the selected camera greater than a predetermined disappearance threshold. The predetermined disappearance threshold can be 5%. This would amount to someone disappearing from view as far as the system is concerned.

Another way to identify anomalies is to consider dwell times for individuals to be within the field of view of each camera. Here the databases would further include typical dwell times for each of the cameras. An anomaly can be flagged by recognition of an individual at a camera who remains in view of that camera for a time that falls outside a corresponding and predetermined dwell time range. This predetermined dwell time range can be +/− two standard deviations from a corresponding mean dwell time for that camera.

In addition to such single-event flagging, an anomaly can be flagged by two or more observations being jointly anomalous. To utilize the probability for situations where the user takes several less common paths, one could multiply the probabilities of the last several transitions and comparing this product to a threshold of something like 5%. One potential issue with this scheme is that it assumes that each transition is independent. A more robust scheme would include entries in the database that contain the conditional probability of a transition given the preceding transition (or several preceding transitions).

When a person moves out of field of view of one camera and into the field of view of another, a record is made of the time taken to do this. Accumulation of such data over a period of time will allow typical transit times to be determined. In the case when an individual is in the field of view of two cameras at the same time, the time between these two cameras can be taken to be zero. This provides a starting point for the system to begin refining the database. It also gives useful pieces of information such as where and for how long people are not in the view of a camera. It also provides information on which cameras are at angles which are suitable for facial recognition.

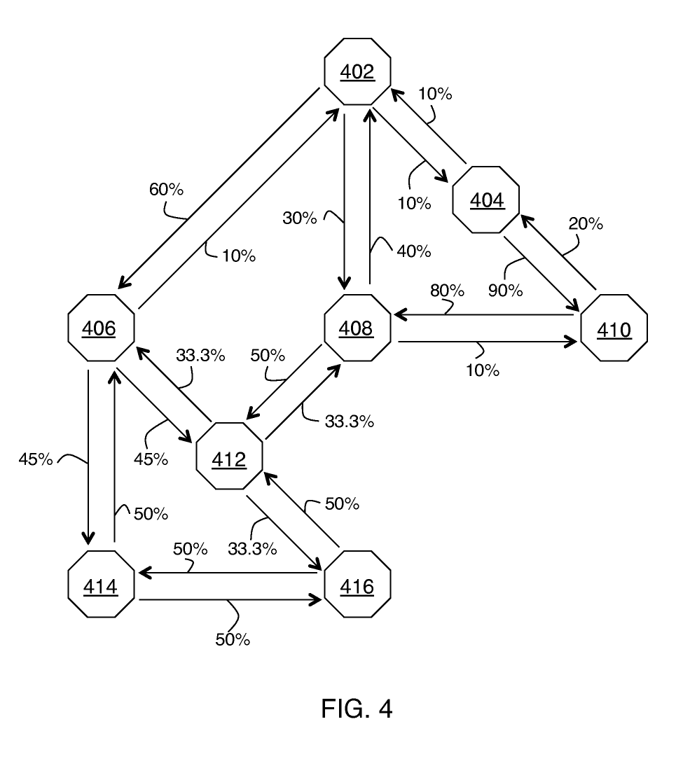

Over time, the system can track multiple users throughout the region of interest and can update the database to represent the average time between cameras. In addition to the transit time associated with each pair of cameras, there is also a corresponding transition probability. A person seen at a camera location can have multiple possibilities for where he or she is seen next. Over time, as people are seen moving from camera to camera, their movements are tallied and the corresponding transition probabilities can be estimated and added to the database. FIG. 4 shows an example of how such probabilities might look in practice. Here an exemplary set of transition probabilities between camera locations 402, 404, 406, 408, 410, 412, 414, and 416 is shown. In this example, the probabilities shown are probabilities for leaving a camera location and arriving at another camera location. Thus the probabilities for going from camera 402 to cameras 406, 408 and 404 are 60%, 30% and 10% respectively.

Different databases can be created for different situations. These databases can correspond to two or more different modes of the target region. The modes of the target region can be: workday start, workday end, shift change, lunchtime, night, weekend, and holiday. For example, in a corporate setting, many people would be entering the building in the morning and entering the workspace. At lunch, people would be going from their workstations to the cafeteria. At the end of the day, people would be going out of the building. Different databases could be created for different times of day in this case.

In addition, in situations where the same people are seen by the cameras over multiple days (i.e. in an office building) a database could be created for each employee at specific times. Typical behavior for each individual would be learned over time. This would amount to having databases corresponding to two or more individuals associated with the target region. Here behavioral analysis can be performed on a per user basis or on a combination basis with the general database. While some deviation from the database norm would be tolerated for an individual (i.e. for meetings in commonly trafficked areas mid-day), any large deviation from the database would be flagged. For example, a person going into a different department's lab on a Saturday night could be flagged for review. This amounts to anomaly identification performed by comparing observations to individual databases and to a general database of overall facility traffic.

Databases corresponding to two or more employment categories associated with the target region can also be employed, since normal behavior for one job category could be highly unusual for someone in a different job category. For example, an executive going to building facilities areas could be flagged.

The database provides for both limiting the bandwidth and processing power required for facial recognition and also allows for behavioral analysis. When a person leaves the view of a camera, that camera can signal to other cameras which are relatively likely to see that person next. These downstream cameras thus know when to expect the individual to appear. When an individual comes within view, facial recognition can be performed by these downstream cameras. Faces which are expected are checked first. Since the vast majority of faces seen by this camera should have been seen by an upstream camera, this decreases the number of faces the camera must check against on average thus lowering the workload on the facial recognition system. If a face is not in the list of expected faces or if the system is not sure of the match, a deeper search can be conducted but this should be the exception and not the rule. This amounts to passing information from one camera to another about likely future events, thereby facilitating real-time face recognition.

Additional pattern recognition through different database algorithms could be introduced. For example, recognized faces can be compared to a predetermined black list of unauthorized individuals, or to a predetermined white list of authorized individuals. Another possibility is to compare recognized faces to a maintained list of individuals who have passed a perimeter check for access and have not exited through the perimeter.

1. A surveillance method comprising:
providing two or more cameras;
installing the two or more cameras in a target region;
automatically constructing at least one database that includes at least typical transit times between camera locations and transition probabilities between camera locations;
wherein the at least one database is automatically constructed from observations of normal traffic in the target region combined with automatic facial recognition;
performing real-time anomaly identification by comparing real-time surveillance data with the at least one database.

2. The method of claim 1, wherein the real-time anomaly identification is triggered by an observed transit time that falls outside a corresponding predetermined transit time range, and wherein the predetermined transit time range is +/− two standard deviations from a mean transit time.

3. The method of claim 1, wherein the real-time anomaly identification is triggered by an observed transition having a corresponding transition probability in the database that is less than a predetermined transition probability threshold, and wherein the predetermined transition probability threshold is 5%.

4. The method of claim 1, wherein the real-time anomaly identification is triggered by two or more observations being jointly anomalous.

5. The method of claim 1, wherein the target region comprises one or more buildings in a secure facility.

6. The method of claim 1, wherein the real-time anomaly identification is triggered by recognition of an individual at a selected camera location who was not recognized at any camera having a transition probability to the selected camera greater than a predetermined appearance threshold, and wherein the predetermined appearance threshold is 5%.

7. The method of claim 1, wherein the real-time anomaly identification is triggered by recognition of an individual at a selected camera location who was not recognized at any camera having a transition probability from the selected camera greater than a predetermined disappearance threshold, and wherein the predetermined disappearance threshold is 5%.

8. The method of claim 1, further comprising comparing recognized faces to a predetermined black list of unauthorized individuals.

9. The method of claim 1, further comprising comparing recognized faces to a predetermined white list of authorized individuals.

10. The method of claim 1, further comprising comparing recognized faces to a maintained list of individuals who have passed a perimeter check for access and have not exited through the perimeter.

11. The method of claim 1, further comprising performing an initialization run where individuals having markers to facilitate automatic identification walk throughout the target region.

12. The method of claim 1, wherein the at least one database includes two or more databases corresponding to two or more different modes of the target region.

13. The method of claim 1, wherein the modes of the target region are selected from the group consisting of: workday start, workday end, shift change, lunchtime, night, weekend, and holiday.

14. The method of claim 1, wherein the at least one database includes two or more individual databases corresponding to two or more individuals associated with the target region.

15. The method of claim 1, wherein the at least one database includes two or more databases corresponding to two or more employment categories associated with the target region.

16. The method of claim 1, further comprising passing information from one camera to another about likely future events, thereby facilitating real-time face recognition.

17. The method of claim 1, wherein the at least one database further includes typical dwell times that individuals remain in view of each of the one or more cameras.

18. The method of claim 17, wherein the real-time anomaly identification is triggered by recognition of an individual at a selected camera who remains in view of the selected camera for a time that falls outside a corresponding and predetermined dwell time range, and wherein the predetermined dwell time range is +/− two standard deviations from a mean dwell time.

19. The method of claim 14, wherein anomaly identification is performed by comparing observations to the individual databases and to a general database of overall facility traffic.

20. The method of claim 1, further comprising automatically updating the at least one database according to observations of normal traffic in the target region combined with automatic facial recognition.
